(19) United States
(12) Patent Application Publication
(10) Pub. No.: US 2021/0168233 A1
(43) Pub. Date: Jun. 3, 2021

(54) CASE-RETAINED MOBILE DEVICE ANCHOR AND METHOD

(71) Applicant: Jacinth Beadle-Exum, Cliffside Park, NJ (US)

(72) Inventor: Jacinth Beadle-Exum, Cliffside Park, NJ (US)

(21) Appl. No.: 16/267,375

(22) Filed: Feb. 4, 2019

Related U.S. Application Data
(60) Provisional application No. 62/625,761, filed on Feb. 2, 2018.

(51) Int. Cl. H04M 1/04; E05B 73/00

(52) U.S. Cl. CPC H04M 1/04; E05B 73/0005

(57) ABSTRACT

An anchoring device; the anchoring device has a ring, a base, and a wire. The base is affixed to the ring. The wire has two ends which are each affixed to the base so that the wire forms a loop sized to run around the edge of a cell phone under a backplate. In this way, the anchoring device can be affixed to the phone as securely as possible without modifying or damaging the phone, and the ring provides a mounting location for a lanyard or other retention device.

### CROSS-REFERENCE TO RELATED APPLICATION(S)

The present application is related to and claims priority to U.S. Provisional Patent Application No. 62/625,761 filed Feb. 2, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of mobile devices of existing art and more specifically relates to smartphone accessories.

### RELATED ART

With the advent of practical, portable cell phones, and more recently smartphones, the average individual has become dependent on the constant presence and use of cell phones. As a result, it is often perceived to be necessary to keep a cell phone on one's person at all times. As users continue to use cell phones for an increasing number of functions, keeping track of the phone and preventing misplacement can become difficult. This is exacerbated by the compact, slim, and drag-free designs of modern cell phones. Additionally, users may accidentally drop their phone, leading to extensive damages and repairs. A suitable solution is desired.

U.S. Pat. No. 5,938,137 to Harold T. Poulson relates to a cellular phone leash. The described cellular phone leash includes a leash attached to a cell phone case and a spring retractable leash cord in a housing pivotally attached to the belt which will prevent dropping and damage to a cell phone in a case clipped to the belt. The leash housing is pivotally attached to a locking belt hook that cannot easily be accidentally removed.

### SUMMARY OF THE INVENTION

In view of the foregoing disadvantages inherent in the known smartphone accessory art, the present disclosure provides a novel case-retained mobile device anchor and method. The general purpose of the present disclosure, which will be described subsequently in greater detail, is to provide an efficient and effective case-retained mobile device anchor and method.

An anchoring device is disclosed herein. The anchoring device has a ring, a base, and a wire. The base is affixed to the ring. The wire has two ends which are each affixed to the base so that the wire forms a loop sized to run around the edge of a cell phone under a backplate.

According to another embodiment, a method of retaining a cell phone is also disclosed herein. The method of retaining a cell phone includes providing the above-described anchoring device and using as described herein.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a case-retained mobile device anchor and method, constructed and operative according to the teachings of the present disclosure.

FIG. 1 is a perspective view of the anchoring-device during an ‘in-use’ condition, according to an embodiment of the disclosure.

FIG. 2 is a perspective view of the anchoring-device of FIG. 1 being installed into a mobile-device, according to an embodiment of the present disclosure.

FIG. 3 is a perspective view of the anchoring-device of FIG. 1, according to an embodiment of the present disclosure.

FIG. 4 is a detailed side perspective view of the anchoring-device of FIG. 1, according to an embodiment of the present disclosure.

FIG. 5 is a flow diagram illustrating a method of use for retaining a cell phone, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a smartphone accessory and more particularly to a case-retained mobile device anchor and method as used to improve the retention of a cell phone.

Generally, the case-retained mobile device anchor is an accessory which provides a mounting location on a cell phone or similar device. The anchor includes a ring, a base, and a wire. Both ends of the wire are affixed to the base and form a loop which is sized to ‘run around’ the cell phone. Many mobile devices have a removable backplate, and a channel or ridge under the backplate, which leaves enough room for such a thin wire as is provided to fit under the backplate and securely constrict to the internal structure or housing of the phone. When the backplate is affixed back to the phone, it retains the wire to the phone. In this way, the anchoring device can be affixed to the phone as securely as possible without modifying or damaging the phone, and the ring provides a mounting location for a lanyard or other retention device.

The base may be circular and may be attached to the ring by a swivel in some embodiments. Preferably, the base and/or the wires are able to pass through the backplate using an existing hole. When this is not the case, it may be necessary to modify the backplate. In one embodiment, the anchor device may be provided in a kit having a backplate for a particular mobile device model, with the kit backplate being modified with a relief or other structural modification to accommodate the base of the anchor device. In yet further embodiments, kits may be available that provide anchoring devices with bases that are tailored to a particular phone model and are shaped and contoured to interface with the mobile device housing, backplate, etc. for that model in a secure manner.

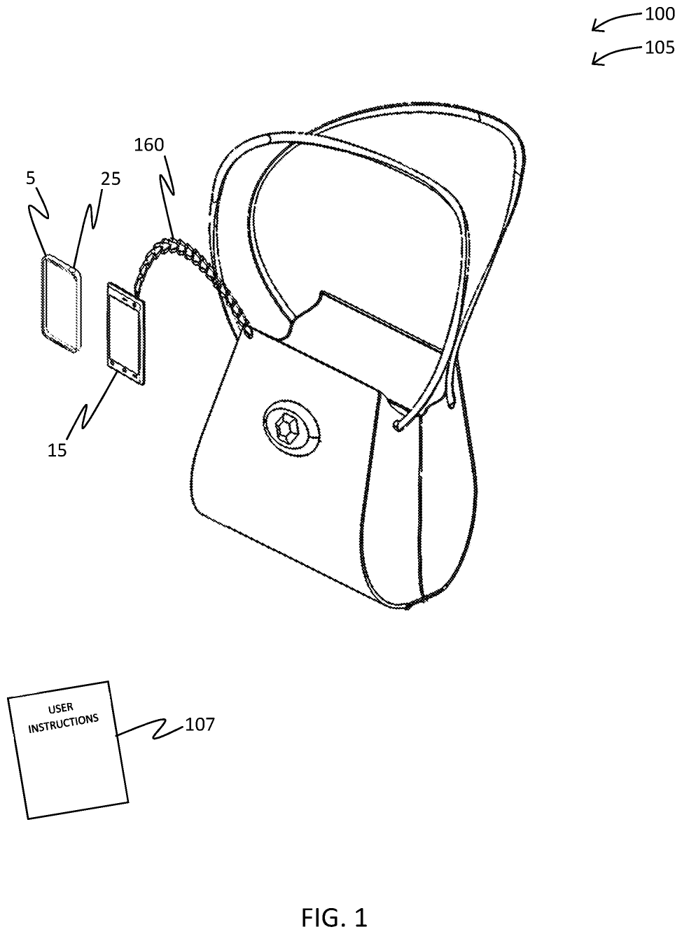

Referring now more specifically to the drawings by numerals of reference, there is shown in FIGS. 1-4, various views of an anchoring device 100.

FIG. 1 shows an anchoring device 100 during an ‘in-use’ condition 50, according to an embodiment of the present disclosure. Here, the anchoring device may be beneficial for use to retain a cell phone. Anchoring-device 100 may be able to anchor retention-device or tether 160 to mobile-device 15.

According to one embodiment, the anchoring-device 100 may be arranged as a kit 105. In particular, the anchoring-device 100 may further include a set of instructions 107. The instructions 107 may detail functional relationships in relation to the structure of the anchoring anchoring-device 100 such that the anchoring anchoring-device 100 can be used, maintained, or the like, in a preferred manner. In one embodiment, backplate 5 is a component of kit 105 alongside anchoring-device 100. In this embodiment, backplate may be a modified backplate having relief 25 as shown. Relief 25 may be semi-circular. Relief 25 may be dimensioned to accommodate anchoring-device 100 as it protrudes for backplate 5 when in attachment to mobile-device 15. Backplate 5 may be custom tailored to a particular model of mobile-device 15. Tether 160 may also be a component of kit 105. Tether 160 may be removably attached to ring 110. Tether 160 may be a metallic chain, a fibrous lanyard, or a polymer lanyard in various embodiments.

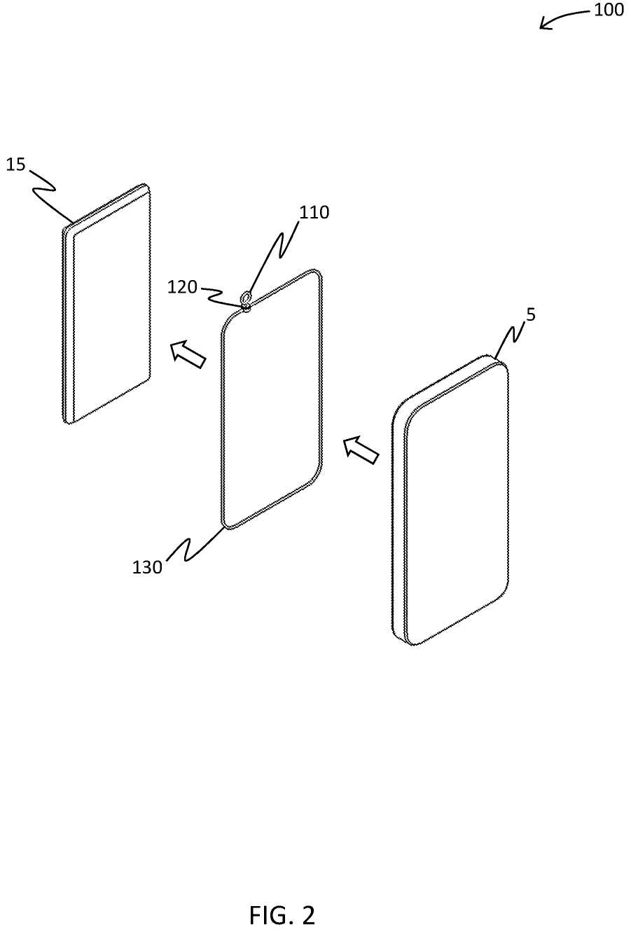

FIG. 2 shows the anchoring device 100 of FIG. 1 being attached to a mobile device, according to an embodiment of the present disclosure. As illustrated, the anchoring anchoring-device 100 may include ring 110, base 120, and wire 130. Wire 130 may form a loop which is secured by base 120. The loop formed by wire 130, as illustrated, may be sized to fit around and circumscribe a portion of mobile-device 15 which in normal use is concealed by backplate 5.

Backplate 5 may be assembled to mobile-device 15 with wire 130 sandwiched in between backplate 5 and mobile-device 15 in the position shown, such that anchoring-device 100 is securely retained to mobile-device 15 by backplate 5 covering wire 130. Wire 130 may be constructed of beryllium, steel, brass, or other resilient materials in various embodiments. Preferably, the diameter of wire 130 is no larger than two millimeters. Base 120 and ring 110 may each be constructed of brass in some embodiments.

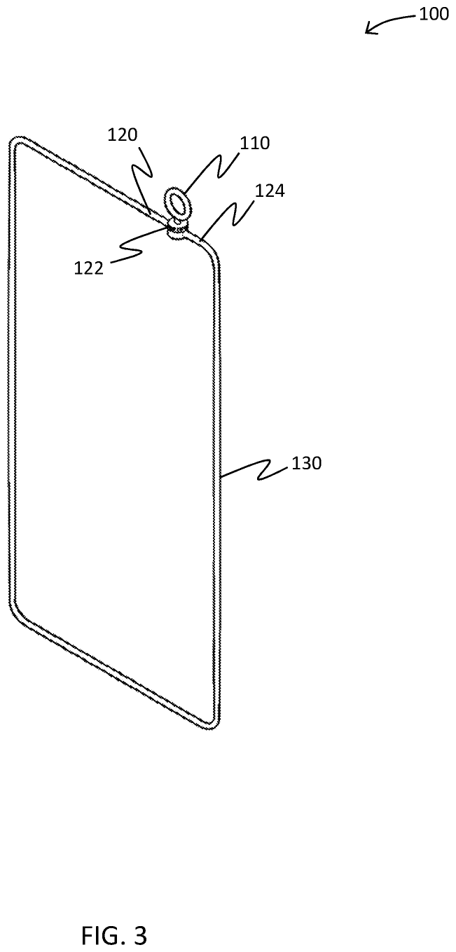

FIG. 3 is a perspective view of the anchoring device 100 of FIG. 1, according to an embodiment of the present disclosure. Anchoring -device 100 may include ring 110, base 120, and wire 130. Base 120 may be affixed to ring 110. Wire 130 may have first-end 122 and second-end 124, defining opposite ends of wire 130. First-end 122 and second-end 124 may each be affixed to base 120, such that wire 130 is able to circumscribe mobile-device 15. Wire 130 may be defined by a wire-length and a wire-diameter. The length of wire 130 and the diameter of wire 130 may be specifically dimensioned to fit underneath mobile-device backplate 5 and circumscribe mobile-device 15 without substantial slack.

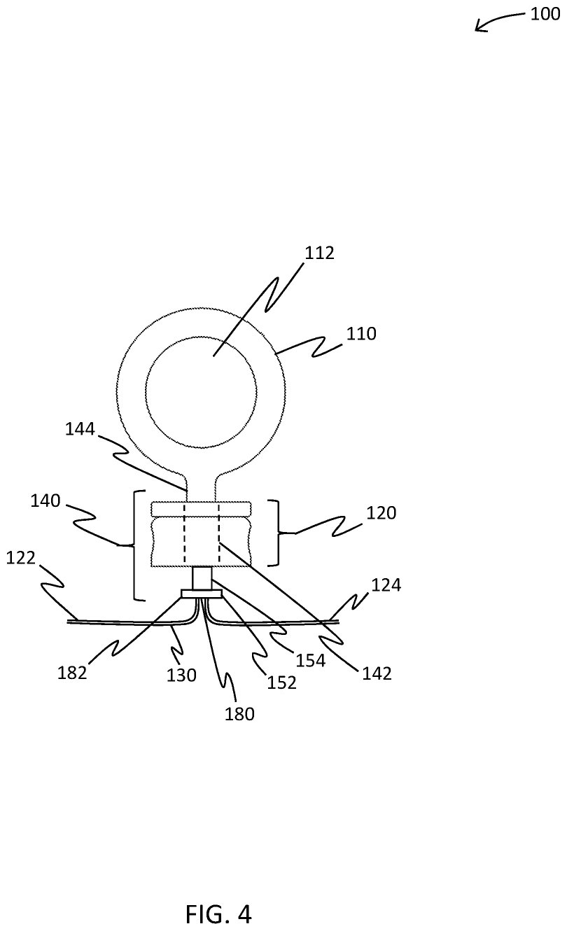

FIG. 4 is a detailed side perspective view of the anchoring device 100 of FIG. 1, according to an embodiment of the present disclosure. Anchoring-device 100 may also include swivel 140 affixing base 120 to ring 110. Swivel 140 may include swivel-aperture 142 and shaft 144. Shaft 144 may be disposed within and be axially rotatable within swivel-aperture 142. Swivel-aperture 142 may be integrated with base 120, and shaft 144 may be integrated with ring 110. In this way, ring 110 may rotate relative to base 120 while still being retained to base 120. Shaft 144 may itself include rim 152 and shank 154. Rim 152 and shank 154 may each be cylindrical and concentric to each other, with rim 152 being wider than shank 154, such that shank 154 may spin freely within swivel-aperture 142. Rim 152 may impinge upon base 120, such that shaft 144 may not be withdrawn from swivel-aperture 142. Ring 110 may be defined by ring-aperture 112. Ring-aperture 112 may be circular, having a diameter which is sufficiently large to enable tether 160 (FIG. 1) to pass through ring-aperture 112. The diameter of ring 110 measures at least three millimeters.

Base 120 may include tensioning device 180. Tensioning device 180 may itself rotatable element 182 integrated into tensioning device 180, tensioning device 180 being configured to constrict wire 130 about mobile-device 15 (FIG. 1). In some embodiments, tensioning device may be integral or indistinguishable from rim 152. First-end 122 of wire 130 and second-end 124 of wire 130 may each be affixed to rotatable element 182, such that neither first-end 122 of wire 130 or second-end 124 of wire 130 are affixed centrally to rotatable element 182. In this way, first-end 122 of wire 130 and second-end 124 of wire 130 may be separated from each other by at least one millimeter, enabling wire 130 to constrict and alternatively expand about mobile-device 15 (FIG. 1) when rotatable element 182 is turned relative to mobile-device 15 (FIG. 1).

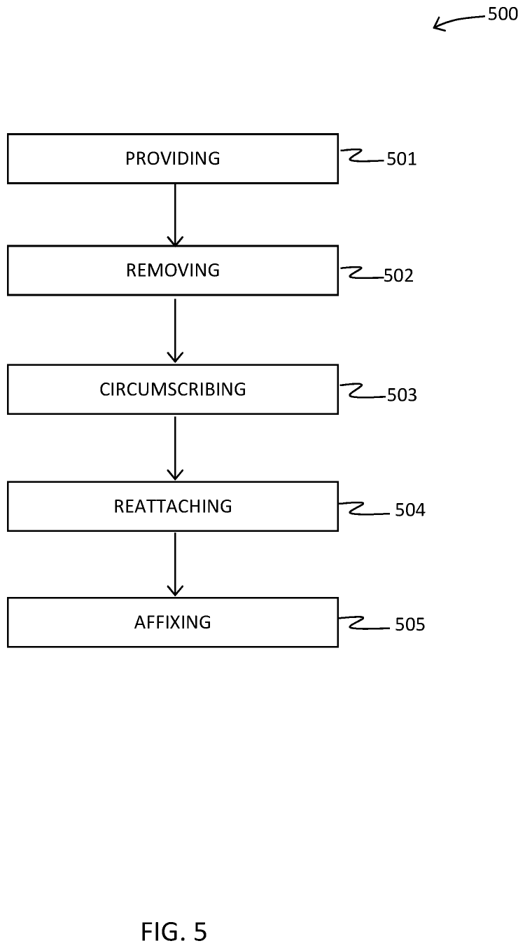

FIG. 5 is a flow diagram illustrating a method for retaining a cell phone 500, according to an embodiment of the present disclosure. In particular, the method for retaining a cell phone 500 may include one or more components or features of the anchoring device 100 as described above. As illustrated, the method for retaining a cell phone 500 may include the steps of: step one 501, providing the anchoring-device of FIG. 1; step two 502, removing the backplate from the mobile-device; step three 503, circumscribing the mobile-device; step four 504, reattaching the backplate to the mobile-device with the wire of the anchoring device being sandwiched between the backplate and the mobile-device; and step five 505, affixing the retention-device to the ring of the anchoring-device.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for retaining a cell phone, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An anchoring-device able to anchor a retention-device to a mobile-device, the anchoring-device comprising:
a ring;
a base affixed to the ring; and
a wire having a first-end and a second-end, said first-end and said second-end each being affixed to the base, said wire being configured to circumscribe the mobile device, said wire having a wire-length and a wire-diameter, said wire-length and said wire-diameter being dimensioned to fit underneath a mobile-device backplate, such that the wire is able to circumscribe the mobile-device.

2. The anchoring device of claim 1, further comprising a swivel affixing the base to the ring, said swivel comprising a swivel-aperture and a shaft, said shaft being disposed within and axially rotatable within the swivel-aperture.

3. The anchoring device of claim 2, wherein the swivel-aperture is integrated with the base, and the shaft is integrated with the ring, such that the ring may rotate relative to the base while being retained to the base.

4. The anchoring device of claim 2, wherein the shaft further comprises a rim and a shank, the rim and the shank each being cylindrical and concentric to each other, the rim being wider than the shank, such that the shank may spin freely within the swivel-aperture, and the rim may impinge upon the base, such that the shaft may not be withdrawn from the swivel-aperture.

5. The anchoring device of claim 1, wherein the wire is constructed of steel.

8. The anchoring device of claim 1, wherein the wire is constructed of beryllium.

6. The anchoring device of claim 1, wherein the base is constructed of brass.

7. The anchoring device of claim 1, wherein the ring is constructed of brass.

9. The anchoring device of claim 1, wherein the wire-diameter is no larger than two millimeters.

10. The anchoring device of claim 1, wherein the ring defines a ring-aperture, said ring-aperture being circular, said ring-aperture having an aperture-diameter, said aperture-diameter being sufficiently large to enable the retention device to pass through the aperture, said aperture-diameter measuring at least three millimeters.

11. The anchoring device of claim 1, further comprising a tether, said tether being removably attached to the ring.

12. The anchoring device of claim 11, wherein the tether is a metallic chain.

13. The anchoring device of claim 11, wherein the tether is a fibrous lanyard.

14. The anchoring device of claim 11, wherein the tether is a polymer lanyard,

15. The anchoring device of claim 1, wherein the base comprises a tensioning device, said tensioning device having a rotatable element integrated into the tensioning device, said tensioning device being configured to constrict the wire about the mobile-device.

16. The anchoring device of claim 15, wherein the first-end of the wire and the second-end of the wire are each affixed to the rotatable element, such that neither the first-end of the wire or the second-end of the wire are affixed centrally to the rotatable element, and such that the first-end of the wire and the second-end of the wire are separated from each other by at least one millimeter, enabling the wire to constrict and alternatively expand about the mobile-device when the rotatable element is turned relative to the mobile-device.

17. A case-retained anchoring-device able to anchor a retention-device to a mobile-device, the case-retained anchoring device comprising:
a ring;
a base affixed to the ring; and
a wire having a first-end and a second-end, said first-end and said second-end each being affixed to the base, said wire being configured to circumscribe the mobile device, said wire having a wire-length and a wire-diameter, said wire-length and said wire-diameter being dimensioned to fit underneath a mobile-device backplate, such that the wire is able to circumscribe the mobile-device.
further comprising a swivel affixing the base to the ring, said swivel comprising a swivel-aperture and a shaft, said shaft being disposed within and axially rotatable within the swivel-aperture;
wherein the swivel-aperture is integrated with the base, and the shaft is integrated with the ring, such that the ring may rotate relative to the base while being retained to the base;
wherein the shaft further comprises a rim and a shank, the rim and the shank each being cylindrical and concentric to each other, the rim being wider than the shank, such that the shank may spin freely within the swivel-aperture, and the rim may impinge upon the base, such that the shaft may not be withdrawn from the swivel-aperture; and
wherein the ring defines a ring-aperture, said ring-aperture being circular, said ring-aperture having an aperture-diameter, said aperture-diameter being sufficiently large to enable the retention device to pass through the aperture, said aperture-diameter measuring at least three millimeters.

18. The anchoring device of claim 17, further comprising set of instructions; and
wherein the anchoring device is arranged as a kit; and
wherein the kit further comprises a backplate having a relief for accepting the base of the anchoring device.

19. A method of anchoring a retention device to a mobile device, the method comprising the steps of:
providing the anchoring-device of claim 1;
removing the backplate from the mobile-device;
circumscribing the mobile-device;
reattaching the backplate to the mobile-device with the wire of the anchoring device being sandwiched between the backplate and the mobile-device; and
affixing the retention-device to the ring of the anchoring-device.
